(19) United States
(12) Patent Application Publication
(10) Pub. No.: US 2026/0094591 A1
(43) Pub. Date: Apr. 2, 2026

(54) SYSTEMS AND METHODS FOR INTERPRETING AND TRANSLITERATING THE LYRICS OF A SONG IN FOREIGN LANGUAGES

(71) Applicant: Michael Merkur, Thornhill (CA)

(72) Inventor: Michael Merkur, Thornhill (CA)

(21) Appl. No.: 19/343,699

(22) Filed: Sep. 29, 2025

Related U.S. Application Data
(60) Provisional application No. 63/699,991, filed on Sep. 27, 2024.

(51) Int. Cl. G10H 1/36; G06F 16/632; G06F 40/268; G09B 15/00

(52) U.S. Cl. CPC G10H 1/361; G06F 16/632; G06F 40/268; G09B 15/00; G10H 2220/011

(57) ABSTRACT

The present disclosure provides a non-transitory computer readable medium having instructions stored thereon that, when executed by a processing device, cause the processing device to carry out an operation comprising: ingesting metadata associated with a first song including a plurality of first song lyrics; dividing the plurality of first song lyrics into corresponding lyric blocks; encoding, via a phonetic color-number pairing, each lyric block by determining a first consonantal sound of each lyric, associating the first consonantal sound with a predetermined color-number pairing, and color-coding a plurality of corresponding lyric blocks based on the predetermined color-number pairing; generating structured grids comprised of the corresponding color-coded lyric blocks and displaying the structured grids via client devices.

### CROSS-REFERENCE TO RELATED APPLICATIONS

This application claims priority to U.S. Provisional Patent Application No. 63/699,991, titled SYSTEMS AND METHODS FOR INTERPRETING AND TRANSLITERATING THE LYRICS OF A SONG IN FOREIGN LANGUAGES, filed Sep. 27, 2024, which is hereby incorporated by reference in its entirety.

### FIELD OF THE INVENTION

The present disclosure relates to systems and methods for processing and displaying textual content from musical compositions, and more particularly to a system that converts song lyrics from any language into a standardized visual representation using a color-number mapping scheme based on phonetic characteristics to enable universal comprehension and real-time synchronization with musical performances, and storing the same.

### INTRODUCTION

Music represents a universal form of human expression that transcends cultural and linguistic boundaries. Digital music streaming platforms have revolutionized how people access and consume musical content, providing instant access to millions of songs from diverse cultures and languages worldwide. These platforms serve global audiences who speak different languages and use various writing systems, creating unprecedented opportunities for cross-cultural musical discovery and appreciation.

The globalization of music consumption has created new challenges in how listeners interact with and understand musical content in foreign languages. While melodic and rhythmic elements of music can be appreciated universally, lyrical content remains largely inaccessible to listeners who do not understand the language in which a song is performed. This linguistic barrier limits the depth of engagement that listeners can have with foreign music, preventing them from fully appreciating the artistic and cultural significance of the lyrical content.

Current approaches to addressing language barriers in music consumption suffer from several technical limitations. Traditional translation services can convert lyrics from one language to another, but these translations do not enable listeners to follow along with the original performance in real-time. Transliteration systems that convert text from one writing system to another provide phonetic approximations, but these systems are fragmented across different languages and lack standardization in format and presentation. Additionally, existing lyric display systems are not optimized for the fast-paced, rhythmic nature of musical performance, making it difficult for listeners to synchronize their understanding with the audio content.

The technical challenges are compounded by the diversity of writing systems used globally. Languages employing non-Latin alphabets, such as Arabic, Chinese, Japanese, Korean, Hebrew, and others, present additional complexity for listeners familiar only with Latin-based writing systems. Current systems lack a unified approach to represent diverse linguistic content in a format that can be universally understood and easily processed during musical performance.

A technical solution that addresses these challenges involves developing a systematic method for converting song lyrics from any language into a standardized visual representation that enables real-time comprehension and engagement. Such a system would provide a computational framework for mapping phonetic elements of lyrics to visual codes, creating a universal format that transcends specific writing systems while preserving the temporal structure necessary for musical synchronization. This approach would enable listeners to engage more deeply with foreign musical content by providing a consistent, learnable system for following along with lyrics regardless of the original language or writing system used.

### SUMMARY

This Summary is provided to introduce a selection of concepts in a simplified form that are further described below in the Detailed Description. This Summary is not intended to identify key features or essential features, nor is it intended to limit the scope of the claims included herewith.

Aspects of the present disclosure may be directed to a non-transitory computer readable medium having a set of instructions stored thereon that, when executed by a processing device, cause the processing device to carry out an operation. The operation may comprise ingesting, via an application programming interface integrated with one or more music streaming platforms, metadata associated with a first song from the one or more music streaming platforms. The metadata associated with the first song may include at least a plurality of first song lyrics. The operation may further comprise dividing, via one or more natural language processing tools, the plurality of first song lyrics into a first plurality of corresponding lyric blocks. Moreover, the operation may further comprise encoding, via a phonetic color-number pairing, each of the first plurality of corresponding lyric blocks by determining a first consonantal sound of each of the plurality of first song lyrics, associating the first consonantal sound with a predetermined color-number pairing, and color-coding each of the first plurality of corresponding lyric blocks based on the predetermined color-number pairing. In an embodiment, the operation may additionally generate one or more structured grids comprised of the first plurality of corresponding color-coded lyric blocks. Finally, the operation may also comprise displaying the one or more structured grids via one or more client devices.

According to other aspects of the present disclosure, the non-transitory computer readable medium may include one or more of the following features. The one or more structured grids may be a 7×7 grid comprised of the first plurality of color-coded lyric blocks. The phonetic color-number pairing may pair first consonantal sounds associated with K, G, J, and CH with a yellow-one pairing, first consonantal sounds associated with M and N with a grey-two pairing, first consonantal sounds associated with T, D, and TH with a red-three pairing, first consonantal sounds associated with R and L with a blue-four pairing, first consonantal sounds associated with Y, W, H, and KH with a green-five pairing, first consonantal sounds associated with P, B, F, and V with a purple-six pairing, and first consonantal sounds associated with S, Z, and SH with a brown-seven pairing. The one or more natural language processing tools may be comprised of at least one of NLTK and spaCy. Analyzing the first consonantal sound of each of the plurality of first song lyrics may be performed by a processor of the processing device. The processor may access one or more phonetic mapping tables stored in a data storage of the processing device to perform consonantal sound identification on each of the plurality of first song lyrics. The operation may further comprise storing in a database, the one or more structured grids for subsequent retrieval. The operation may further comprise receiving a search query for a second song, the search query comprising a numerical sequence corresponding to a color-number pairing of a first row of a 7×7 grid comprised of a second plurality of color-coded lyric blocks. The operation may further comprise retrieving the second song upon receipt of the search query.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates an embodiment of an environment in which the present disclosure may be practiced;

FIG. 2 illustrates an embodiment of a block diagram of an electronic device;

FIG. 3 illustrates an embodiment of one or more structured grids;

FIG. 4 illustrates an embodiment of a large grid;

FIG. 5 illustrates an embodiment of a medium grid;

FIG. 6 illustrates an embodiment of a small grid; and

FIG. 7 illustrates an embodiment of a method for interpreting and transliterating the lyrics of songs in foreign languages.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

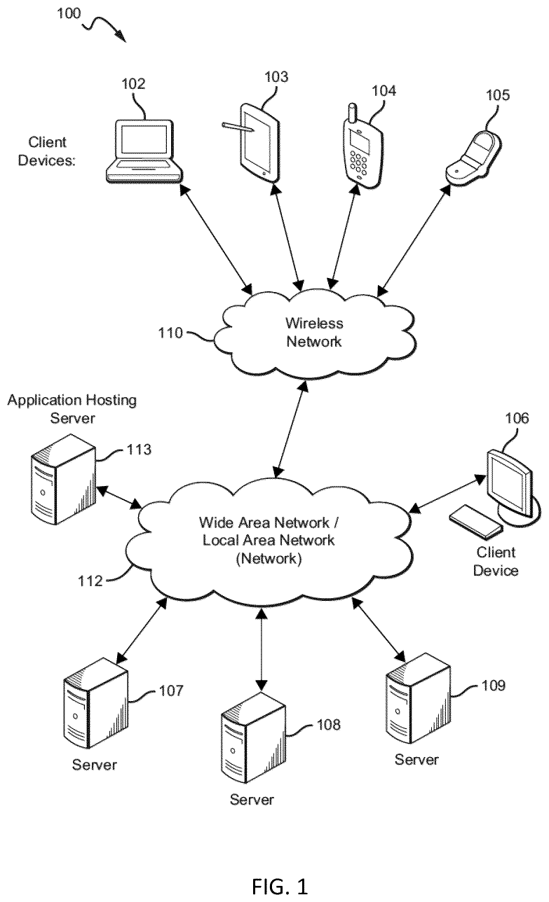

FIG. 1 illustrates components of one embodiment of an environment in which the present disclosure may be practiced. Not all of the components may be required to practice the present disclosure, and variations in the arrangement and type of the components may be made without departing from the spirit or scope of the present disclosure. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. The client devices 102-106 may include, for example, at least one of desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

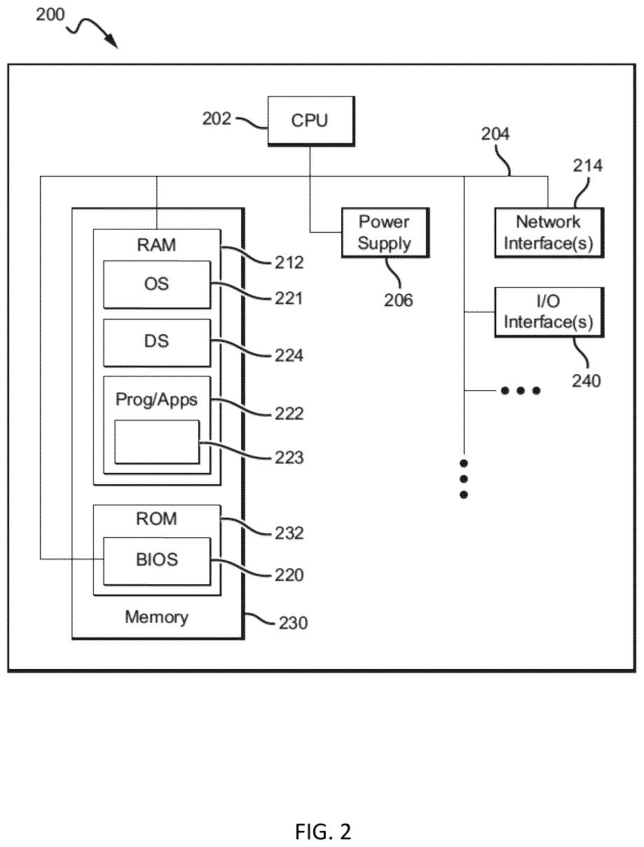

FIG. 2 illustrates a block diagram of an electronic device 200 that can implement one or more aspects of systems and methods for interpreting and transliterating the lyrics of a song in foreign languages (the “Engine”) according to one embodiment of the present disclosure. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the present disclosure. The elements may exist on a single computer or be distributed among multiple computers, servers, devices or entities.

The power supply 206 contains one or more power components and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can case processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system and method implementing the Engine, may run a variety of operating systems, including personal computer operating systems such as Windows, iOS or Linux, and mobile operating systems such as IOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Arca Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, and the like. Access technologies such as 2G, 2.5G, 3G, 4G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPV6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present disclosure include apparatuses, systems, and methods implementing the Engine. Embodiments of the present disclosure may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

In an embodiment, the system may receive, process, generate and/or store time series data. The system may include an application programming interface (API). The API may include an API subsystem. The API subsystem may allow a data source to access data. The API subsystem may allow a third-party data source to send the data. In one example, the third-party data source may send JavaScript Object Notation (“JSON”)-encoded object data. In an embodiment, the object data may be encoded as XML-encoded object data, query parameter encoded object data, or byte-encoded object data.

Aspects of the present disclosure may relate to a system for interpreting and transliterating the lyrics of songs (the “system”). Specifically, the system may convert song lyrics of any language into a standardized visual representation. By converting song lyrics into a standardized visual representation, the system may address challenges associated with consuming music content across different languages and writing systems.

For instance, existing tools for translating languages provide semantic understanding but fail to address challenges with phonetic and visual recognition, which prevents listeners from engaging with the lyrical content of a song in a foreign language. Moreover, the diversity of writing systems worldwide creates inconsistent user experiences when attempting to navigate, search, or organize foreign language music collections.

The system of the present disclosure addresses these challenges through a structured approach that converts textual lyrical content into a standardized visual representation format. Such a structured approach may process song lyrics by dividing the textual content into manageable segments and applying a systematic encoding methodology. For example, the system may employ a color-number mapping scheme, wherein specific colors and numerical values are assigned to each lyric of a song based on its phonetic characteristics, particularly the first consonantal sounds of words.

The system may establish a fixed relationship between seven distinct colors, corresponding numerical values, and/or groups of consonantal sounds. This relationship enables consistent encoding of textual content regardless of the source language or writing system. The mapping process converts diverse linguistic inputs into a uniform visual output format that maintains phonetic relationships while providing visual consistency.

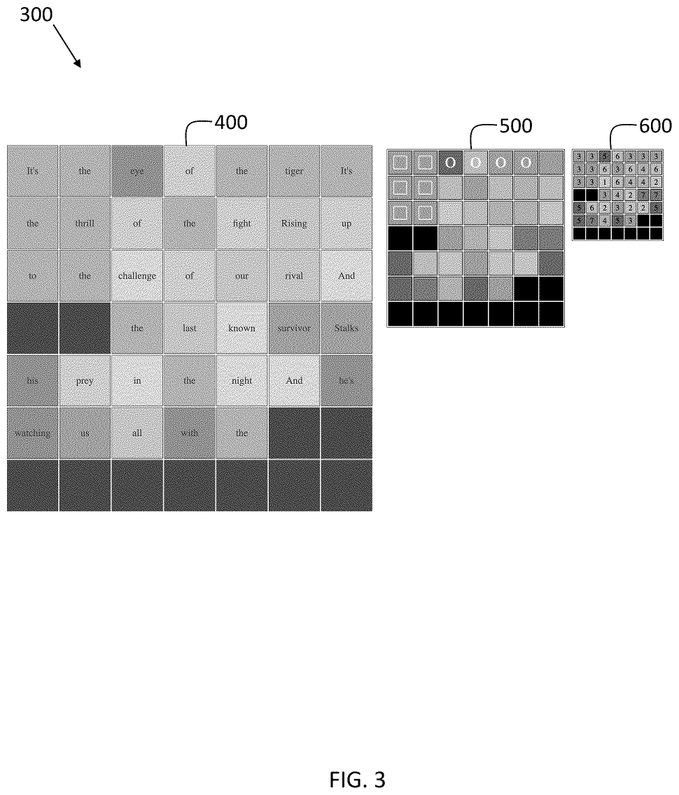

Referring to FIG. 3, the system may subsequently generate visual representations in the form of one or more structured grids 300 that display the encoded lyrical content. These grids 300 may utilize a standardized format that accommodates varying lengths of lyrical content while maintaining consistent visual presentation. As a nonlimiting example, the structured grids 300 may comprise a 7×7 square grid featuring 49 individual square blocks. Such a grid may enable listeners to follow along with songs in a foreign language by providing a bridge between the original lyrical content and a universally interpretable format. This grid-based approach allows for systematic organization of the encoded song lyrics and facilitates pattern recognition that aids in memorization and comprehension of the foreign language material.

In addition to facilitating user memorization and comprehension, the system provides improved search functionality. To illustrate, the aforementioned color-number encoding system, provides a standardized search interface transcending language barriers. For instance, users unfamiliar with non-Latin based alphabets (e.g., Arabic alphabet, Chinese characters, Cyrillic alphabet, etc.) may be unable to input song titles, artist names, and the like using standard keyboard interfaces. Meaning, current search algorithms, which rely heavily on exact text matching and phonetic similarity algorithms, fail when users cannot input foreign language characters or when transliteration systems produce inconsistent results across different languages and writing systems.

Thus, the system may address database indexing inefficiencies occurring when traditional search systems attempt to cross-reference phonetic approximations across different transliteration standards. By converting diverse linguistic inputs into standardized numerical and color sequences, the system enables more efficient database queries and reduces the computational resources required for currently existing matching algorithms.

In an embodiment, the system facilitates faster learning of musical lyrics in a foreign language. For example, if said listener's primary language is English, the system facilitates the listener's improved learning of musical lyrics in Arabic, Japanese, Korean, etc. Moreover, in another embodiment, the system may facilitate the listener's understanding of musical lyrics in a foreign language. As a nonlimiting example, lyrics in a foreign language may be translated, via a translation tool (e.g., Google Translate), to the listener's primary language; however, mere translation of said lyrics alone does not enable the listener to sing along in the foreign language. Meaning, the current art is unable to facilitate the listener's understanding of the foreign lyrics. Additionally, the system is configured to facilitate the understanding of lyrics in a foreign language, such that the listener may sing along with said lyrics.

Furthermore, the system is configured to encode, via the phonetic color-number encoding methodology, the lyrics of a song in a foreign language via mapping the lyrics. In an embodiment, said encoding and mapping of song lyrics in foreign languages improve the field of ethnomusicology by enhancing the listener's understanding of said foreign lyrics. For example, encoding foreign song lyrics converts said lyrics into a universally understandable format (i.e., the one or more structured grids 300). In such an example, lyrics utilizing alphabets other than the Latin alphabet may be encoded into the Latin alphabet, thus enabling the listener to follow along with said foreign lyrics.

As mentioned above, the system may encode the lyrics of a song. In one embodiment, the system may assign a color code to song lyrics. To illustrate, the color code may be based upon a seven day week, wherein a color is assigned to a specific day of the week. As a nonlimiting example, Sunday may be assigned the color yellow, Monday may be assigned the color grey, Tuesday may be assigned the color red, Wednesday may be assigned the color blue, Thursday may be assigned the color green, Friday may be assigned the color purple, and Saturday may be assigned the color brown.

Moreover, the aforementioned colors may also be assigned a hexadecimal value for uniform visual encoding. For example, the color yellow may be assigned the number one, the color grey may be assigned the number two, the color red may be assigned the number three, the color blue may be assigned the number four, the color green may be assigned the number five, the color yellow may be assigned the number six, and the color brown may be assigned the number seven.

Furthermore, the color-number encoding system described above, may correspond with a phonetic sound of a word. In one embodiment, the phonetic sound may be derived from the first consonantal sounds of the word.

As a nonlimiting example, the phonetic color-number encoding system may be as follows: (1) the yellow-one pairing may correspond with the consonantal sounds associated with K, G, J, and CH; (2) the grey-two pairing may correspond with the consonantal sounds associated with M and N; (3) the red-three pairing may correspond with the consonantal sounds associated with T, D, and TH; (4) the blue-four pairing may correspond with the consonantal sounds associated with R and L; (5) the green-five pairing may correspond with the consonantal sounds associated with Y, W, H, and KH; (6) the purple-six pairing may correspond with the consonantal sounds associated with P, B, F, and V; and (7) the brown-seven pairing may correspond with the consonantal sounds associated with S, Z, and SH.

In an embodiment, the phonetic color-number encoding system described above may be derived from a KANDLS grouping method in linguistics. The KANDLS grouping method classifies consonants in phonetics based on said consonants' place of articulation. The KANDLS grouping method classifies consonants pursuant to the following: K: Velar (e.g., /k/, /g/)—produced at the back of the mouth; A: Alveolar (e.g., /t/ and /d/)—produced with the tongue against the alveolar ridge (just behind the upper front teeth); N: Nasal (e.g., /m/, /n/, /n/)—produced by allowing air to pass through the nose; D: Dental (e.g., /θ/as in “think”, /ð/as in “this”)—produced with the tongue against the teeth; L: Lateral (e.g., /1/)—produced by allowing air to flow around the sides of the tongue; and S: Sibilant (e.g., /s/, / [symbol] /)-characterized by a hissing sound.

Using the phonetic color-number encoding system described above, the system may organize a song into a visual representation, such as the one or more structured grids 300. To do so, the system may first ingest a song. To illustrate, the system may integrate with applications (e.g., YouTube) via APIs to access song metadata, including title, artist, album information, release year, lyrical content data, and the like. The system may retrieve lyrical content from multiple sources, including local storage on the one or more client devices 102-106, remote databases accessed via the one or more client devices 102-106 through networks 110 or 112, or by real-time extraction from streaming music services. The processor 202 of the electronic device 200 manages the ingestion of song metadata, accessing data storage 224 via communications bus 204, and storing the acquired lyrics in random access memory 212.

Upon ingesting the song, the system may preprocess the song data. Specifically, the system may normalize the textual format of the lyrics, remove extraneous characters, and/or format elements that could interfere with subsequent processing stages.

After preprocessing the lyrics, the system may segment the lyrics into manageable processing units. For example, the system, may divide the lyrics into one or more lyric blocks comprising the structured grids 300. As a nonlimiting example, a single lyric block may correspond with and/or contain an individual lyric. Thus, each lyric block may represent a discrete segment that can be independently processed. Further, in examples where the one or more structured grids comprise the 7×7 grid, the system will feature up to 47 individual lyric blocks, with two positions reserved for fixed reference markers (described in more detail below). Additionally, the processor 202 may execute segmentation algorithms stored in the program 223 to analyze the song lyrics and determine appropriate division points between lyric blocks.

Further, the system may handle excess lyrics exceeding a predetermined word limit by either discarding the excess lyrics, redistributing the excess content among existing lyric blocks, or creating additional structured grids when the excess content reaches sufficient volume to warrant separate processing.

Subsequent to segmenting the lyrics, the system may assess the first consonantal phonetic sound each lyric makes. For instance, the system may analyze the first consonantal sound of each lyric and map said sound to the predetermined color-number pairings according to the aforementioned encoding scheme. To illustrate, the processor 202 may access phonetic mapping tables stored in the data storage 224 to perform the consonantal sound identification and color-number assignment operations.

In some embodiments, the system may handle special cases where lyrics contain intrinsic numerical or coloristic meanings that override the default phonetic mapping approach, allowing for direct assignment of colors or numbers based on semantic content rather than phonetic characteristics (described in more detail below). As a nonlimiting example, the lyric “four” may be given the color-number pairing blue-four, instead of the purple-six pairing for words beginning with an “F” consonantal sound.

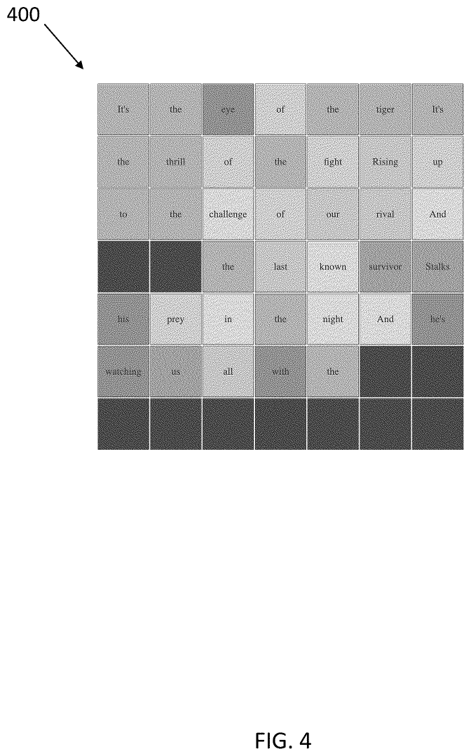

Furthermore, the system may then assign each lyric a color and number via the phonetic color-number encoding system described above. For example, the system may apply the color-number encoding methodology to the segmented lyrical content described above. As a nonlimiting example, the lyrics “it's the eye of the tiger,” would correspond with the following colors and numbers: “it's”=red and three, “the”=red and three, “eye”=green and five, “of”=purple and six, “the”=red and three, and “tiger”=red and three (illustrated in FIGS. 3-6).

After each lyric comprising the song has been encoded (i.e., assigned a color-number pairing), the system may generate a visual representation of the encoded lyrics. In one example, the system may place each individual lyric, its color, and/or its number into a corresponding lyric block forming the structured grids 300.

For instance, the system may construct the one or more structured grids 300 that organize the color-number encoded lyrics into systematic visual patterns that facilitate user comprehension and pattern recognition. Further, the system may display the same via the one or more client devices 102-106.

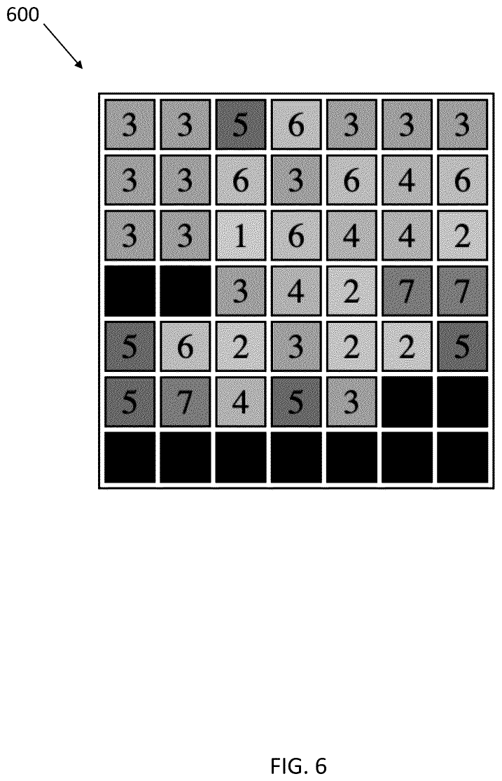

In one example, the one or more structured grids 300 may comprise a 7×7 grid comprised of 49 individual lyric blocks. In some embodiments, one or more black squares may be placed in row four, columns one and two of the 7×7 grid to provide consistent visual anchors across all generated representations for user orientation. In continuance of the example above, the lyrics “it's the eye of the tiger,” would be arranged into six individual lyric blocks in the first row of the 7×7 grid (illustrated in FIGS. 3 and 6), wherein the “it's” lyric block would be filled with the color red the number three; the “the” lyric block would be filled with the color red the number three; the “eye” lyric block would be filled with the color green and the number five; the “of” lyric block would be filled with the color purple and the number six; the “the” lyric block would be filled with the color red the number three; and the “tiger” lyric block would be filled with the color red the number three.

As previously mentioned, the system provides improved search functionality. To illustrate, the song “Eye of the Tiger” by Survivor begins with the lyrics “Risin' up, back on the street did my time, took my chances.” The system may encode said lyrics according to the phonetic color-number encoding methodology. Thus, said lyrics would be encoded as follows: (1) “risin'” is given the blue-four color-number pairing; (2) “up” is given the purple-six color-number pairing; (3) “back” is given the purple-six color-number pairing; (4) “on” is given the grey-two color-number pairing; (5) “the” is given the red-three color-number pairing; (6) “street” is given the brown-seven color-number pairing; and (7) “did” is given the red-three color-number pairing. Each of the first seven lyrics would be placed in an individual lyric block comprising the first row of the 7×7 grid. Thus, to search for the song “Eye of the Tiger” a user may input the first seven numbers, based on the color-number pairings, of the first seven lyrics of the song. Meaning, the user may input “4662373” into a search bar of the system to find the song “Eye of the Tiger.” Such a standardized search function may improve upon current search algorithms, that fail to account for foreign language characters.

In some embodiments, the system may synchronize the display of the one or more structured grids 300 with audio playback of the corresponding song content, thus enabling users to follow along with the lyrical content in real-time. For instance, the system may provide interactive capabilities allowing users to navigate between different lyric blocks, adjust display parameters, or access additional information about the processed song content through the I/O interfaces 240 of the electronic device 200.

Furthermore, the system may incorporate additional processing capabilities. To illustrate, the system may interface with internet-based music libraries to retrieve lyrical content and metadata automatically when users select songs from streaming platforms or digital music collections. To do so, the application server 108 may establish connections with external music services APIs enabling real-time access to lyrical databases and song catalogs.

Moreover, the system may also implement caching mechanisms to store frequently accessed songs and their corresponding visual representations in the content server 109 to reduce processing latency for subsequent requests. The random access memory 212 may maintain temporary storage of recently processed lyric blocks comprising the one or more structured grids 300 to enable rapid retrieval when users navigate between different sections of the same song or return to previously viewed content.

In an embodiment, if one of the one or more lyrics blocks exceeds 47 words, the excess lyrics may be reused. However, in an alternative embodiment, the excess lyrics may be discarded. In yet a further embodiment, if the amount of excess lyrics over 47 is 20 or more, then the system may generate another lyric block for said excess lyrics.

Moving on, with reference to FIGS. 3-6, the one or more structured grids 300 may comprise a small grid 600, a medium grid 500, and a large grid 400. Specifically, the small 600, medium 500, and large 400 grids may comprise a 7×7 grid of differing sizes and visual presentation formats that accommodate various display requirements and user preferences. In an embodiment, the system may generate the small 600, medium 500, and large grids 400 for each encoded song.

To illustrate, the large grid 400 may display the lyric in its corresponding lyric block with said lyric's color-number pairing. In particular, each lyric block comprising the large grid 400 may contain a corresponding lyric and the color from the color-number pairing, enabling users to establish direct connections between the original text and the visual representation. Each lyric block comprising the medium grid 500 may hold one or more geometric symbols 502 (described in further detail below) along with the color from the lyric's color-number pairing. Further, the small grid 600 may only hold the color-number pairing of the lyrics in each lyric block comprising the small grid 600.

In an embodiment, the small 600, medium 500, and large 400 grids may place a black square in row four, columns one and two of the 7×7 grids to orient the user as to where said grids begin. Moreover, any of the remaining 47 grid slots that cannot be filled may also be filled in with the color black (as illustrated in FIGS. 3-6).

The system may generate the large grid 400, medium grid 500, and small grid 600 simultaneously for each processed lyrical segment, enabling users to select the visualization level that corresponds to their display capabilities and learning preferences. The program module 223 within the electronic device 200 may contain algorithms that coordinate the generation of the small grid 600, medium grid 500, and large grid 400 from the same source data. The random access memory 212 may temporarily store the one or more structured grids 300 during the generation process, while the data storage 224 maintains the completed grids 300 for subsequent access. The I/O interfaces 240 may present the different grid types through user interface controls that allow switching between visualization levels without requiring regeneration of the underlying data. The network interface 214 may transmit the generated grids to client devices 102-106 throughout the network system 100, enabling distributed access to the one or more structured grids 300 across multiple platforms and device types.

As stated above, the medium grid 500 may hold one or more geometric symbols 502, along with the color of the color-number pairing in each lyric block. The system may incorporate the geometric symbols 502 to modify the basic color-number mapping to create more visually distinctive and memorable patterns within the medium grid 500. The geometric symbols 502 may operate on the foundational grid structure by introducing strategic modifications that increase pattern recognition capabilities while maintaining the systematic organization of the encoded lyrical content. The geometric symbols 502 address situations where the basic phonetic mapping may produce grids 300 with limited visual appeal or insufficient pattern differentiation. The system may analyze the initial grid configurations and apply targeted modifications by adding the geometric symbols 502 to improve the overall visual characteristics of the transliterated content.

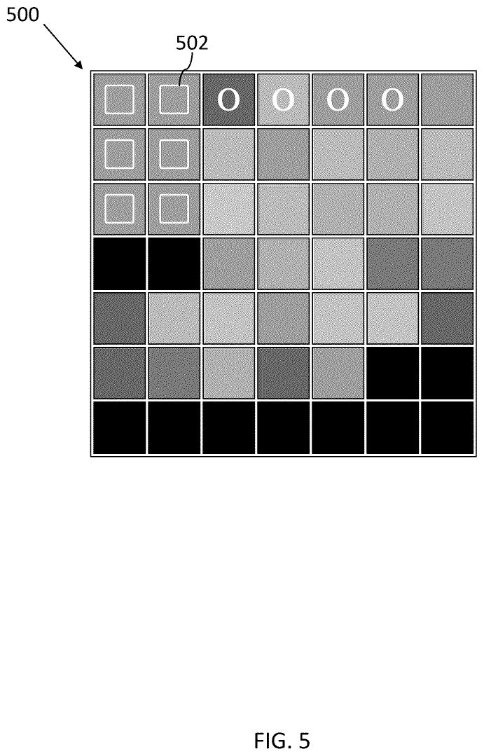

In an embodiment, the one or more geometric symbols 502 may correspond with a pattern of the color-number pairings of the medium grid 500. For example, if a 2×2 grid of the lyric blocks within the medium grid 500 all hold the same color, said lyric blocks may display a square placed therein (illustrated in FIG. 5). In another example, if three or more individual lyric blocks are adjacent to one another in at least one of a diagonal line, a horizontal line, and a vertical line, an arrow may be placed within each of the three or more individual lyric blocks.

For instance, if one of the one or more lyric blocks does not generate the color-number pairing patterns on the medium grid 500 described above, such that no geometric symbols 502 are generated, the system may employ a word-switch algorithm. The word-switch algorithm may implement numberistic and/or coloristic mapping factors.

For example, numberistic mapping factors may assign a color and/or numerical value based on semantic content rather than phonetic characteristics. When the word-switch algorithm encounters lyrics containing meanings tied intrinsically to numerical concepts, the word-switch algorithm may assign color-number pairings that correspond directly to the numerical significance of the lyrical content. The numberistic mapping factors may apply when lyrics represent actual numbers between one and seven in the source language, or when lyrics contain semantic meanings that strongly correlate with numerical concepts within the context of the source material. The word-switch algorithm may evaluate the semantic content of each lyric and determine whether the intrinsic numerical associations justify overriding the standard phonetic mapping approach to achieve improved visual pattern formation.

Concerning the coloristic mapping factors, said factors may provide an alternative assignment method that the word-switch algorithm may employ when standard phonetic mapping produces suboptimal visual results in the structured grids 300. The coloristic mapping factors may assign color-number pairings based on the intrinsic color associations contained within the semantic meaning of specific lyrics. When lyrics contain direct references to colors or semantic concepts that strongly correlate with particular color associations within the context of the lyrics, the word-switch algorithm may apply coloristic mapping factors to achieve more intuitive visual representations. The coloristic mapping factors may recognize lyrics that reference natural elements, emotional states, or cultural symbols that carry established color associations, allowing the word-switch algorithm to create structured grids 300 that reflect these semantic relationships rather than purely phonetic characteristics. For instance, a lyric such as, “honey,” may be assigned the color yellow, when mapping one of the one or more lyric blocks based on a coloristic factor.

The system may further employ word splitting operations to provide an alternative approach to grid modification that increases the granularity of the encoded lyrics by dividing multi-syllabic words into separate components. For instance, the word splitting process may analyze individual words within the lyric blocks to identify candidates that contain two or more syllables and may benefit from subdivision. Each syllable resulting from the splitting operation occupies a separate lyric block and receives independent color-number encoding based on the phonetic characteristics of the syllable's initial consonantal sound. Thus, the word splitting operation increases the total number of encoded lyrics within the structured grids, which may create additional opportunities for pattern formation and visual enhancement.

The word splitting operation may maintain phonetic accuracy by ensuring that each split component retains a recognizable consonantal sound that can be encoded through the established color-number encoding methodology. Words that begin with vowel sounds or contain syllables without clear consonantal initiation may be excluded from the splitting process to avoid complications during lyric encoding. The splitting operation may evaluate the potential impact of syllable separation on the overall configuration of the structured grids 300 and apply the technique selectively to achieve optimal visual results. Multi-syllabic words may be split in various combinations, such as dividing three-syllable words into two components or three separate syllables, depending on the specific requirements of the structured grids 300.

To illustrate, when processing the word “hello,” the system may identify two syllables “he” and “llo” and determine that splitting into “he” and “llo” is permissible because both resulting segments contain consonantal sounds that can be mapped to the color-coding system. For instance, “he” begins with the consonantal sound H (mapped to green-five) and “llo” begins with the consonantal sound L (mapped to blue-four).

Conversely, the system may reject certain word splits that would create segments lacking initial consonantal sounds, such as attempting to divide “apart” into “a” and “part.” The algorithm may detect that the segment “a” begins with a vowel sound rather than a consonant, making it incompatible with the phonetic mapping requirements of the color-coding system, thereby preventing this split from being executed.

For words containing three or more syllables, the system may generate multiple valid splitting combinations to optimize pictogram scoring. When processing “pictogram,” the algorithm may evaluate several division options: a three-way split into “pic,” “to,” and “gram,” a two-way split into “picto” and “gram,” or an alternative two-way split into “pic” and “togram.” Each potential combination may be analyzed for its impact on the overall pictogram score, with the system selecting the division pattern that produces the most visually appealing color arrangements or completes desired geometric patterns within the grid.

The word splitting algorithm may implement dynamic programming techniques to efficiently evaluate all possible syllable combinations for complex words like “complicated,” systematically testing divisions such as “compli” and “cated,” “com,” “pli,” “ca,” and “ted,” or “com” and “plicated” to determine which segmentation pattern yields the highest scoring pictogram configuration.

The one or more structured grids 300 may be further enhanced via a set of rules for black square insertions that may be applied to improve visual pattern formation. The black square insertion rules may specify locations within the one or more structured grids 300 where additional black squares may be placed to create or enhance geometric patterns that improve visual appeal and memorability. The black square insertion guidelines may establish constraints on the number and positioning of inserted black squares to maintain the structural integrity of the one or more structured grids 300 while allowing for strategic modifications that enhance pattern recognition. The black square insertion guidelines may also define relationships between inserted black squares and existing geometric formations to ensure that modifications contribute positively to overall visual coherence.

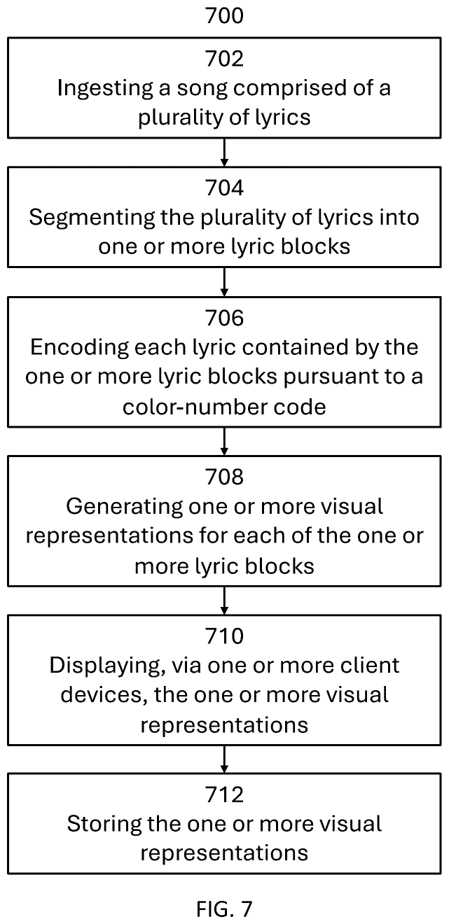

With reference to FIG. 7, the present disclosure may also relate to a method for interpreting and transliterating the lyrics of songs in foreign languages (the “method”) 700. The method 700 addresses the technical challenges associated with foreign language music consumption by establishing a structured workflow that transforms diverse linguistic inputs into standardized visual outputs. The method 700 operates through a series of discrete steps (described in more detail below) that handle different aspects of the lyric conversion process. The method 700 may be implemented across the network system 100 using the distributed computing resources provided by the application server 108 and content server 109. The method 700 may enable users to access transliteration services through various client devices including the one or more client devices 102-106.

The method 700 may be comprised of at least a first step 702 that handles the initial acquisition and preparation of song content for processing. For instance, the first step 702 may involve ingesting a song comprised of a plurality of lyrics, along with associated metadata such as, the song's title, artist, year of release, etc.

During the first step 702, the method 700 may retrieve lyrical content from various sources including local storage on the electronic device 200, remote databases accessed through the wide area network 112, or real-time extraction from streaming music services. As a nonlimiting example, the first step 702 may integrate with applications (e.g., YouTube) via APIs to access such song metadata. Furthermore, the processor 202 may coordinate the ingestion of the song by accessing the data storage 224 through the communications bus 204 to store the acquired lyrical content in the random access memory 212. The first step 702 may also involve preprocessing operations that normalize the textual format of the lyrics and remove extraneous characters or formatting elements that could interfere with subsequent processing stages.

In a second step 704 of the method 700, the song may be processed, wherein the plurality of lyrics are segmented into manageable processing units. The second step 704 may divide the plurality of lyrics into one or more lyric blocks that contain predetermined ranges of textual content. To illustrate, the one or more lyric blocks may correspond with and/or contain an individual lyric. Thus, each lyric block may represent a discrete segment that can be independently processed through the subsequent stages of the method 700.

The processor 202 may execute segmentation and/or tokenization algorithms stored in the program module 223 to analyze the lyrical content and determine appropriate division points between lyric blocks (e.g., every line, every lyric, etc.). As a nonlimiting example, while dividing the plurality of lyrics, said lyrics may be tokenized, wherein the text comprising the plurality of lyrics may be broken down into individual lyrics using natural language processing tools including, NLTK and/or spaCy. The second step 704 may handle excess lyrics that exceed the predetermined word limits by either discarding the excess content, redistributing the excess content among existing lyric blocks, or creating additional lyric blocks when the excess content reaches sufficient volume to warrant separate processing.

For example, the method 700 may employ various segmentation and/or tokenization algorithms implementing natural language processing that accurately identify word boundaries across multiple writing systems including logographic, syllabic, and alphabetic scripts, whereas prior art systems typically handle only single writing system formats. The method 700 may utilize pattern recognition algorithms that automatically detect recurring structural elements such as verses, choruses, and bridges through acoustic fingerprinting and textual analysis, improving upon manual segmentation approaches that require human intervention for each song.

The method 700 may implement unicode-aware tokenization algorithms that process text by analyzing character properties and script boundaries to identify word separators across different writing systems. For logographic scripts such as Chinese or Japanese, the method 700 may employ dictionary-based tokenization algorithms that compare character sequences against lexical databases to identify semantic word boundaries where spaces are not used as delimiters. The tokenization process may utilize maximum matching algorithms that scan character sequences from left to right, identifying the longest possible word matches to create discrete lyric blocks containing semantically coherent units.

For syllabic writing systems such as Korean Hangul or Japanese Hiragana, the method 700 may implement syllable boundary detection algorithms that analyze phonetic patterns and morphological structures to segment text into processable units. The tokenization algorithms may employ finite state automata that recognize syllable patterns and apply language-specific rules to determine appropriate division points between lyric blocks while preserving phonetic integrity.

For alphabetic scripts, the method 700 may implement whitespace-based tokenization enhanced with punctuation analysis and capitalization pattern recognition to handle contractions, hyphenated words, and proper nouns within lyrical content. The tokenization process may apply regular expression patterns that identify word boundaries while accounting for musical notation, timing markers, and formatting elements commonly found in lyrical transcriptions, ensuring that each resulting lyric block contains clean textual content suitable for subsequent phonetic analysis and color-number encoding operations.

Moreover, the method 700 continues with a third step 706 that may apply the color-number encoding methodology described above to the one or more lyric blocks. For instance, the third step 706 may encode each lyric within the one or more lyric blocks using a color-number pairing that assigns specific colors and numerical values based on phonetic characteristics of the individual lyrics contained within the one or more lyric blocks.

The third step 706 may analyze the first consonantal sound of each lyric and map said sound to a predetermined color-number pairing according to the established encoding scheme. As previously mentioned, the phonetic color-number pairings may be as follows: (1) the yellow-one pairing may correspond with the consonantal sounds associated with K, G, J, and CH; (2) the grey-two pairing may correspond with the consonantal sounds associated with M and N; (3) the red-three pairing may correspond with the consonantal sounds associated with T, D, and TH; (4) the blue-four pairing may correspond with the consonantal sounds associated with R and L; (5) the green-five pairing may correspond with the consonantal sounds associated with Y, W, H, and KH; (6) the purple-six pairing may correspond with the consonantal sounds associated with P, B, F, and V; and (7) the brown-seven pairing may correspond with the consonantal sounds associated with S, Z, and SH.

Further, the processor 202 may access phonetic mapping tables stored in the data storage 224 to perform the consonantal sound identification and color-number assignment operations. The step 706 may handle special cases where lyrics contain intrinsic numerical or coloristic meanings that override the default phonetic mapping approach, allowing for direct assignment of colors or numbers based on semantic content rather than phonetic characteristics. For instance, during the third step 706, the method 700 may employ the word-switch algorithm as described above.

After assigning each of the one or more lyric blocks a color-number pairing, the method 700 may advance to a fourth step 708 wherein visual representations of the encoded lyrical content may be generated. For instance, the fourth step 708 may generate one or more structured grids 300 that organize the color-number encoded lyrics into systematic visual patterns that facilitate user comprehension and pattern recognition.

In one example, the one or more structured grids 300 may comprise a 7×7 grid comprised of 49 individual lyric blocks. In some embodiments, one or more black squares may be placed in row four, columns one and two of the 7×7 grid to provide consistent visual anchors across all generated representations for user orientation. Thus, the one or more structured grids 300 will feature up to 47 individual lyric blocks, with two positions reserved for fixed reference markers (described in more detail below). Excess lyrics exceeding the 47 individual lyric blocks may be discarded, redistributed using word-switch algorithms, or placed within additional lyric blocks when the excess content reaches sufficient volume to warrant separate processing.

Additionally, the fourth step 708 may generate multiple variations of the visual representations, including different grid as described above. The fourth step 708 may also incorporate geometric symbols and pattern recognition elements that enhance the visual appeal and memorability of the generated maps.

Moving on, the method 700 may conclude with a fifth step 710 that presents the generated visual representations to users through appropriate display interfaces. The fifth step 710 displays the one or more one or more structured grids 300 via the one or more client devices 102-106 within the network system 100, utilizing the input output interfaces 240 of the electronic device 200 to render the visual content on display screens. The fifth step 710 may coordinate with the network interface 214 to transmit the structured grids 300 from server components such as the application server 108 to client devices through the wireless network 110 or wide area network 112. The fifth step 710 may synchronize the display of the structured grids 300 with audio playback of the corresponding song content, enabling users to follow along with the lyrical content in real-time. The fifth step 710 may also provide interactive capabilities allowing users to navigate between different lyric blocks, adjust display parameters, or access additional information about the processed song content through the input output interfaces 240.

Moving on, the method 700 may conclude with a fifth step 710 that presents the generated visual representations to users through appropriate display interfaces. The fifth step 710 displays the one or more one or more structured grids 300 via the one or more client devices 102-106 within the network system 100, utilizing the input output interfaces 240 of the electronic device 200 to render the visual content on display screens. The fifth step 710 may coordinate with the network interface 214 to transmit the structured grids 300 from server components such as the application server 108 to client devices through the wireless network 110 or wide area network 112. The fifth step 710 may synchronize the display of the structured grids 300 with audio playback of the corresponding song content, enabling users to follow along with the lyrical content in real-time. The fifth step 410 may also provide interactive capabilities allowing users to navigate between different lyric blocks, adjust display parameters, or access additional information about the processed song content through the input output interfaces 240.

The method 700 may further comprise a sixth step 712, wherein the one or more structured grids 300 may be stored in a database for subsequent retrieval and reuse. For instance, during the sixth step 712, the method 700 may cache the processed structured grids 300 in the content server 109 or data storage 224 to reduce computational overhead for future requests involving the same song content.

The storage process may associate the structured grids 300 with metadata including song identifiers, artist information, and encoding parameters to enable efficient database indexing and retrieval operations. In one example, the first seven numbers, based on the corresponding color-number pairings, of the first seven lyrics of a song may be associated with the one or more structured grids 300. Thus, a user may input said numbers into a search to find the corresponding song or songs featuring the inputted seven number code.

The sixth step 712 may implement compression algorithms to optimize storage space while maintaining visual fidelity of the one or more structured grids 300, and may establish expiration policies for cached content to manage database size and ensure content freshness. The caching mechanism may enable rapid access to previously processed songs, improving responsiveness and reduced processing latency when users request frequently accessed musical content.

The method 700 may incorporate additional processing capabilities that enhance the transliteration functionality beyond the basic sequential operations. In some cases, the method 700 may interface with internet-based music libraries to retrieve lyrical content and metadata automatically when users select songs from streaming platforms or digital music collections. The application server 108 may establish connections with external music services through application programming interfaces that enable real-time access to lyrical databases and song catalogs.

The method 700 may also implement caching mechanisms that store frequently accessed songs and their corresponding visual representations in the content server 109 to reduce processing latency for subsequent requests. The random access memory 212 may maintain temporary storage of recently processed lyric blocks to enable rapid retrieval when users navigate between different sections of the same song or return to previously viewed content.

The method 700 may also incorporate multiple enhancement algorithms that modify the basic color-number mapping process to generate more visually appealing and memorable pictographic representations. These enhancement algorithms analyze the initial results and apply strategic modifications when the standard phonetic mapping approach produces visual patterns that lack distinctive characteristics or geometric coherence. The enhancement algorithms operate through systematic evaluation processes that assess the visual quality of generated maps and implement targeted adjustments to improve pattern recognition and memorability. The enhancement algorithms may execute automatically when predetermined conditions are detected, or the enhancement algorithms may operate in response to user preferences that prioritize visual appeal over strict phonetic accuracy.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A non-transitory computer readable medium having a set of instructions stored thereon that, when executed by a processing device, cause the processing device to carry out an operation, the operation comprising the steps of:
ingesting, via an application programming interface integrated with one or more music streaming platforms, metadata associated with a first song from the one or more music streaming platforms,
the metadata associated with the first song including at least a plurality of first song lyrics;
dividing, via one or more natural language processing tools, the plurality of first song lyrics into a first plurality of corresponding lyric blocks;
encoding, via a phonetic color-number pairing, each of the first plurality of corresponding lyric blocks by:
determining a first consonantal sound of each of the plurality of first song lyrics,
associating the first consonantal sound with a predetermined color-number pairing, and
color-coding each of the first plurality of corresponding lyric blocks based on the predetermined color-number pairing;
generating one or more structured grids comprised of the first plurality of corresponding color-coded lyric blocks; and
displaying the one or more structured grids via one or more client devices.

2. The non-transitory computer readable medium of claim 1, wherein the one or more structured grids are a 7×7 grid comprised of the first plurality of color-coded lyric blocks.

3. The non-transitory computer readable medium of claim 1, wherein the phonetic color-number pairing pairs:
first consonantal sounds associated with K, G, J, and CH with a yellow-one pairing;
first consonantal sounds associated with M and N with a grey-two pairing;
first consonantal sounds associated with T, D, and TH with a red-three pairing;
first consonantal sounds associated with R and L with a blue-four pairing;
first consonantal sounds associated with Y, W, H, and KH with a green-five pairing;
first consonantal sounds associated with P, B, F, and V with a purple-six pairing; and
first consonantal sounds associated with S, Z, and SH with a brown-seven pairing.

4. The non-transitory computer readable medium of claim 1, wherein the one or more natural language processing tools are comprised of at least one of NLTK and spaCy.

5. The non-transitory computer readable medium of claim 1, wherein analyzing the first consonantal sound of each of the plurality of first song lyrics is performed by a processor of the processing device.

6. The non-transitory computer readable medium of claim 5, wherein the processor accesses one or more phonetic mapping tables stored in a data storage of the processing device to perform consonantal sound identification on each of the plurality of first song lyrics.

7. The non-transitory computer readable medium of claim 1, further comprising:
storing in a database, the one or more structured grids for subsequent retrieval.

8. The non-transitory computer readable medium of claim 7, further comprising:
receiving a search query for a second song,
the search query comprising a numerical sequence corresponding to a color-number pairing of a first row of a 7×7 grid comprised of a second plurality of color-coded lyric blocks.

9. The non-transitory computer readable medium of claim 8, further comprising:
retrieving the second song upon receipt of the search query.
